(19) United States
(12) Patent Application Publication
(10) Pub. No.: US 2014/0160416 A1
(43) Pub. Date: Jun. 12, 2014

(54) ARRAY SUBSTRATE FOR TFT-LED, METHOD OF MANUFACTURING THE SAME, AND DISPLAY DEVICE

(71) Applicants: BEIJING BOE DISPLAY TECHNOLOGY CO., LTD., Beijing (CN); Boe Technology Group Co., Ltd., Beijing (CN)

(72) Inventors: Xiao Wang, Beijing (CN); Kun Cao, Beijing (CN)

(73) Assignees: BEIJING BOE DISPLAY TECHNOLOGY CO., LTD., Beijing (CN); Boe Technology Group Co., Ltd., Beijing (CN)

(21) Appl. No.: 14/096,798

(22) Filed: Dec. 4, 2013

(30) Foreign Application Priority Data
Dec. 6, 2012 (CN) 201210520833.1

(51) Int. Cl. G02F 1/1343

(52) U.S. Cl. CPC G02F 1/134309
USPC 349/139; 445/24

(57) ABSTRACT

An array substrate, a method of manufacturing the same, and a display device are provided to effectively eliminate the afterimage phenomenon and improve the display quality of display device. A pixel electrode, a common electrode, a first TFT and a second TFT are provided in a sub-pixel region defined by Nth and (N+1)th gate lines of a plurality of gate lines and two data lines of the plurality of data lines, and a multi-dimensional electric field is formed when the pixel electrode and the common electrode are powered. A first gate electrode of the first TFT is connected to the (N+1)th gate line, a first source electrode of a first TFT is connected to one of the two data lines, a first drain electrode of the first TFT is connected to the pixel electrode; a second gate electrode of a second TFT is connected to the Nth gate line, a second drain electrode of the second TFT is connected to the pixel electrode, a second source electrode of the second TFT is connected to the common electrode; and the Nth gate line comprises any one of the plurality of gate lines except the last one, and during a gate line scanning process for one frame in the array substrate, the Nth gate line is always scanned in advance of the (N+1)th gate line.

### CROSS-REFERENCE TO RELATED APPLICATION

This application claims the benefit of Chinese Patent Application No. 201210520833.1 filed on Dec. 6, 2012 in the State Intellectual Property Office of China, the whole disclosure of which is incorporated herein by reference.

### BACKGROUND OF THE INVENTION

1. Field of the Invention

Embodiments of the present invention relates to the technical field of LCD, more especially, to array substrate for Thin Film Transistor-Liquid Crystal Display (TFT-LCD), method of manufacturing the same, and the display device comprising the array substrate.

2. Description of the Related Art

Recently, LCDs have been widely used in various electronic display products, such as computers, televisions, and mobile phones. People pay more and more attention to the problems that may occur during displaying of the LCDs, such as afterimage phenomenon.

When a LCD is used to convert an image or is shut off, many charges are accumulated on the pixel electrodes due to coupling of storage capacitor, floating electrode and the like. Electric fields will be formed between the pixel electrodes and common electrodes by these charges, so that the liquid crystal molecules between the pixel electrodes and the common electrodes are kept in deflected state. In this way, the image resulted from last deflection of the liquid crystal molecules still exists on the display screen, which is called as the afterimage phenomenon. As the charges being slowly released, the state of liquid crystal molecules is gradually changed, and the afterimage on the display screen will slowly disappear. The occurrence of the afterimage will significantly affect display quality.

### SUMMARY OF THE INVENTION

The present invention has been made to overcome or alleviate at least one aspect of the above mentioned disadvantages.

Accordingly, embodiments of the present invention are to provide an array substrate, a method of manufacturing method the same to effectively eliminate the afterimage phenomenon and improve the display quality of display device.

In an embodiment according to one aspect of the present invention, there is provided an array substrate for using in a TFT-LCD, comprising:

a transparent substrate;

a plurality of gate lines and a plurality of data lines positioned crosswise on the transparent substrate to define a plurality of sub-pixel regions; and

a pixel electrode, a common electrode, a first TFT and a second TFT provided in a sub-pixel region defined by the Nth and (N+1)th gate lines of the plurality of gate lines and two data lines of the plurality of data lines, and the pixel electrode and the common electrode forming a multi-dimensional electric field when powered;

wherein a first gate electrode of the first TFT is connected to the (N+1)th gate line, a first source electrode of the first TFT is connected to one of the two data lines, a first drain electrode of the first TFT is connected to the pixel electrode; a second gate electrode of the second TFT is connected to the Nth gate line, a second drain electrode of the second TFT is connected to the pixel electrode, a second source electrode of the second TFT is connected to the common electrode; and

the Nth gate line comprises any one of the plurality of gate lines except the last one, and during a gate line scanning process for one frame in the array substrate, the Nth gate line is always scanned in advance of the (N+1)th gate line.

In an embodiment according to a further aspect of the present invention, a method for manufacturing an array substrate used in a TFT-LCD is provided, comprising steps of:

forming a plurality of gate lines, a plurality of data lines, a plurality of pixel electrodes, a plurality of common electrodes, a plurality of first TFTs and a plurality of second TFTs on a transparent substrate;

wherein a sub-pixel region is defined by the Nth and (N+1)th gate lines of the plurality of gate lines and two data lines of the plurality of data lines, one pixel electrode, one common electrode, one first TFT and one second TFT are included in the sub-pixel region, and a multi-dimensional electric field is formed by the pixel electrode and the common electrode when powered;

a first gate electrode of the first TFT is connected to the (N+1)th gate line, a first source electrode of the first TFT is connected to one of the two data lines, a first drain electrode of the first TFT is connected to the pixel electrode;

a second gate electrode of the second TFT is connected to the Nth gate line, a second drain electrode of the second TFT is connected to the pixel electrode, a second source electrode of the second TFT is connected to the common electrode; and

the Nth gate line comprises any one of the plurality of gate lines except the last one, and during a gate line scanning process for one frame in the array substrate, the Nth gate line is always scanned in advance of the (N+1)th gate line.

In the method for manufacturing the array substrate, the step of forming the plurality of gate lines, the plurality of data lines, the plurality of pixel electrodes, the plurality of common electrodes, the plurality of first TFTs and the plurality of second TFTs in the transparent substrate comprises steps of:

forming a gate metal film on the transparent substrate, and at least forming the Nth gate line, the (N+1)th gate line, the first gate electrode and the second gate electrode through patterning process; wherein the first gate electrode is electrically connected to the (N+1)th gate line, and the second gate electrode is electrically connected to the Nth gate line;

forming a gate insulation layer on the transparent substrate to cover the first and the second gate electrodes;

forming active layers at positions on the gate insulation layer corresponding to the first gate electrode and the second gate electrode;

forming a transparent conductive film on the gate insulation layer in which the active layers are formed, and forming the common electrode through patterning process;

forming a first passivation layer on the gate insulation layer to cover the common electrode and the active layers, and forming a first via passing through the first passivation layer on the common electrode through patterning process;

forming a metal film on the first passivation layer, and at least forming the first source electrode, the first drain electrode, the second source electrode, the second drain electrode and the data line through patterning process, wherein the second source electrode is connected to the common electrode through the first via;

forming a second passivation layer film on the first passivation layer, and forming second vias passing through the second passivation layer on first drain electrode and the second drain electrode through patterning process respectively; and

forming a transparent conductive film on the second passivation layer, and forming the pixel electrode through patterning process, wherein the pixel electrode is connected respectively to the first drain electrode and the second drain electrode through the second vias in the second passivation layer.

In the method for manufacturing the array substrate, the step of forming the plurality of gate lines, the plurality of data lines, the plurality of pixel electrodes, the plurality of common electrodes, the plurality of first TFTs and the plurality of second TFTs in the transparent substrate comprises steps of:

forming a gate metal film on the transparent substrate, and at least forming the Nth gate line, the (N+1)th gate line, the first gate electrode and the second gate electrode through patterning process; wherein the first gate electrode is electrically connected to the (N+1)th gate line, and the second gate electrode is electrically connected to the Nth gate line;

forming a gate insulation layer on the transparent substrate to cover the first and the second gate electrodes;

forming active layers at positions on the gate insulation layer corresponding to the first gate electrode and the second gate electrode;

forming a first passivation layer film on the gate insulation layer, in which the active layers are formed, to cover the active layers;

forming a metal film on the first passivation layer, and at least forming the first source electrode, the first drain electrode, the second source electrode, the second drain electrode and the data line through patterning process;

forming a second passivation layer film on the first passivation layer, and forming, through patterning process, first vias passing through the second passivation layer on the first drain electrode and the second drain electrode respectively, and a second via passing through the second passivation layer on the second source electrode; and

forming a transparent conductive film on the second passivation layer, and forming the pixel electrode and the common electrode that are arranged alternatively through patterning process, wherein the pixel electrode is connected to the first drain electrode and the second drain electrode respectively through the first vias, and the common electrode is connected to the second source electrode through the second via.

In an embodiment according to a still further aspect of the present invention, there is provided a display device comprising a color film substrate and the array substrate according to claim 1 assembled by a cell assembly process.

### BRIEF DESCRIPTION OF THE DRAWINGS

The above and other features of the present invention will become more apparent by describing in detail exemplary embodiments thereof with reference to the accompanying drawings, in which:

FIG. 1 is a partial top view of an array substrate for TFT-LCD according to an exemplary embodiment of the present invention;

FIG. 2 is a sectional view along lines A1-A2 and B1-B2 in the array substrate for TFT-LCD of FIG. 1;

FIG. 3 is a sectional view of array substrate for TFT-LCD according to another exemplary embodiment of the present invention; and

FIG. 4 is an equivalent circuit diagram of the array substrate for TFT-LCD according to embodiments of the present invention.

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

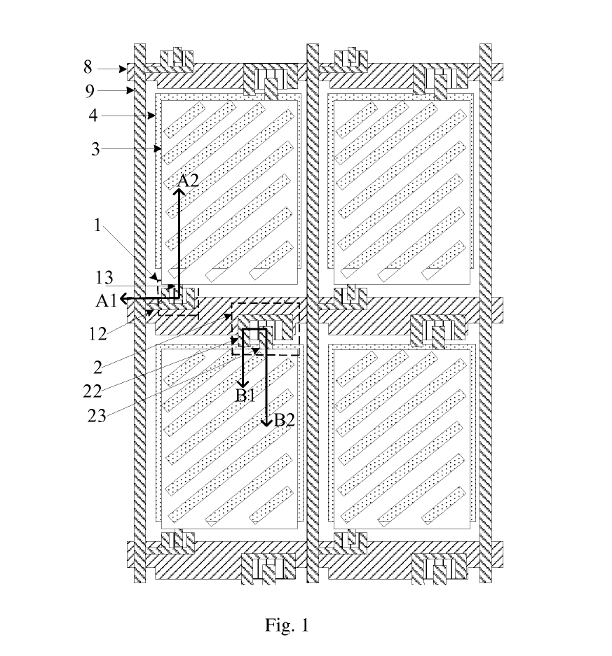

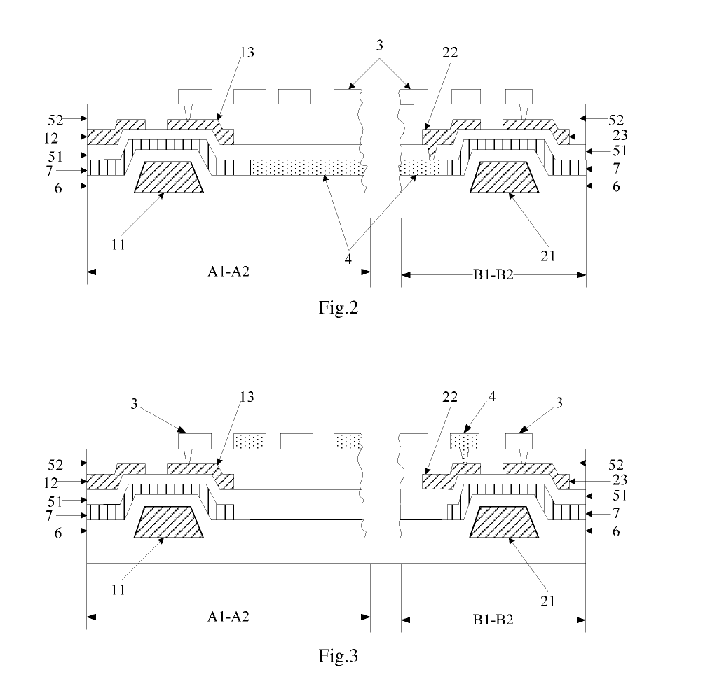

As shown in FIGS. 1, 2 and 4, an array substrate for TFT-LCD is provided according to an exemplary embodiment of the present invention. The array substrate comprises: a transparent substrate; a common electrode line positioned on the transparent substrate; a plurality rows of gate lines 8 and a plurality columns of data lines 9 positioned crosswise on the transparent substrate to define a plurality of sub-pixel regions, one of which being defined by the Nth, (N+1)th gate lines 81, 82 of the plurality of gate lines 8 and two data lines of the plurality of data lines. The sub-pixel region is provided with a pixel electrode 3, a common electrode 4, a first thin-film transistor (TFT) 1 and a second TFT 2. The pixel electrode 3 and the common electrode 4 form a multi-dimensional electric field when powered. The first TFT 1 comprises a first gate electrode 11, a first source electrode 12 and a first drain electrode 13. In the sub-pixel region, the first gate electrode 11 is connected to the (N+1)th gate line 82, the first source electrode 12 is connected to the data line 9, and the first drain electrode 13 is connected to the pixel electrode 3. Further, as shown in FIG. 2, the array substrate also comprises: a gate insulation layer 6 and an active layer 7.

Furthermore, in the sub-pixel region, the second TFT 2 comprises a second gate electrode 21, a second source electrode 22 and a second drain electrode 23. The second gate electrode 21 is connected to the Nth gate line 81, wherein, the Nth gate line 81 may comprise any one of the gate lines in the array substrate except the last one. The second drain electrode 23 is electrically connected to the pixel electrode 3 which is connected to the first drain electrode 13, and the second source electrode 22 is electrically connected to the common electrode. Generally, the common electrode, the gate line and the gate electrode may be formed by the same metal film through patterning process. Alternately, the common electrode, the data line, the source electrode, and the drain electrode may be formed by the same metal film through patterning process.

It is to be noted that, a TFT comprises a gate electrode for applying a turn-on voltage, a source electrode, and a drain electrode. The source electrode and the drain electrode are non-distinctive for having the same function. For the sake of simpleness, in one exemplary embodiment of the present embodiment, the drain electrodes such as the first drain electrode 13 and the second drain electrode are both connected to the pixel electrode; the first source electrode is connected to the data line, the second source electrode is electrically connected to the common electrode.

In all the embodiments of the present invention, when two patterns are “connected”, it means the two patterns are contacted with each other directly. When two patterns are “electrically connected”, it means the two patterns may be contacted with each other directly, or be connected together through other conductors.

In a display device, every time a frame image is displayed, each gate line in the display device should be successively scanned by a gate line scanning device, i.e. a gate line scanning process for one frame is performed. For example, the scan frequency of the gate line scanning device is 64 Hz, which means 64 frames of gate line scanning processes are performed per second, and the display device can display 64 frames of images per second. In the embodiments of the present invention, the (N+1)th gate line is the next gate line of the Nth gate line, and during the gates line scanning process for each frame, the Nth gate line is always scanned in advance of the (N+1)th gate line.

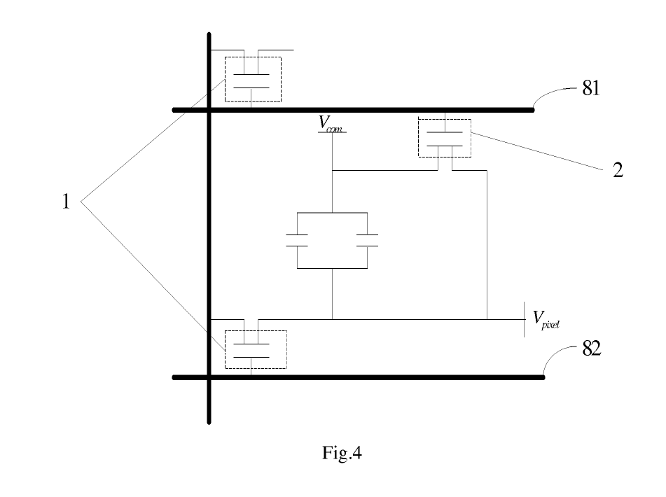

FIG. 4 is an equivalent circuit diagram of the array substrate for TFT-LCD according to embodiments of the present invention. The second TFT 2 is connected to the Nth gate line 81, and when the Nth gate line is being scanned, the second TFT 2 is in operation, so as to turn on the source electrode and the drain electrode of the second TFT 2. The source electrode and the drain electrode of second TFT 2 are respectively electrically connected to the common electrode and pixel electrode corresponding to the first TFT 1 driven by the (N+1)th gate line 82. Wherein, the V_{com} is the voltage of the common electrode, the V_{Pixel} is the voltage of the pixel electrode. The turn-on of the source electrode and the drain electrode of second TFT 2 renders V_{Pixel}=V_{com}, such that the electric potential difference between the common electrode and the pixel electrode corresponding to the first TFT 1 driven by the (N+1)th gate line 82 become zero. Therefore, liquid crystal deflection phenomenon due to accumulation of charges on the pixel electrode is suppressed, the afterimage phenomenon is effectively eliminated, and the display quality of display device is improved.

In the array substrate according to the embodiments of the present invention, each of the Nth gate lines except the last gate line is connected with a second TFT. Correspondingly, the second drain electrode of the second TFT is electrically connected to the pixel electrode which is connected to the first drain electrode of the first TFT driven by the (N+1)th gate line.

In one exemplary embodiment of the present invention, as shown in FIG. 1, the number of the second TFTs driven by the Nth gate line is equal to the number of the first TFTs driven by the (N+1)th gate line. Each of the second drain electrodes and one corresponding first drain electrode are connected to the same pixel electrode. Specifically, the second drain electrode of each of the second TFTs driven by the Nth gate line is one-to-one correspondingly electrically connected to the corresponding pixel electrode which is connected to the first drain electrode of each one of the first TFTs driven by the (N+1)th gate line.

In this way, in the display device of the present invention, when the Nth gate line is being scanned, all the pixel electrodes corresponding to the first drain electrodes of all the first TFTs driven by the (N+1)th gate line are electrically connected with the common electrode, the charges accumulated on the pixel electrodes are released to the common electrode, such that the electric potential difference between the pixel electrode corresponding to the (N+1)th gate line and the common electrode become zero, thereby “clearing” the pixel electrode and suppressing the accumulation of charges on the pixel electrode. Therefore, while the current gate line, such as the Nth gate line, is be scanned by the display device, all the charges accumulated on the pixel electrodes corresponding to the next gate line, such as the (N+1)th gate line, are “cleared or reset”, such that the afterimage phenomenon is suppressed and display quality of display device is improved.

There are two connecting ways that the second drain electrode 23 may be electrically connected to the pixel electrode 3 corresponding to the first TFT driven by the (N+1)th gate line, more specifically:

In the first connecting way (not shown), the second drain electrode 23 of the second TFT driven by the Nth gate line is connected correspondingly to the first drain electrode 13 of the first TFT driven by the (N+1)th gate line. Since the first drain electrode 13 is usually connected with the pixel electrode 3 through a via in a second passivation layer 52, the second drain electrode 23 is electrically connected to the pixel electrode 3 through the first drain electrode 13.

In the second connecting way, as shown in FIG. 1, the second drain electrode 23 of the second TFT driven by the Nth gate line is correspondingly connected to the pixel electrode 3 corresponding to the first TFT 1 driven by the (N+1)th gate line. For example, as shown in FIG. 2, the second drain electrode 23 may directly connected with the pixel electrode 3 through the via in the second passivation layer 52, and the via could be easily formed in the second passivation layer 52 through a patterning process.

The array substrate for TFT-LCD according to the first exemplary embodiment of the present invention may be applied to the production of different types of LCD device, such as the Advanced-Super Dimensional Switching (ADS or AD-SDS) type, the In Plane Switch (IPS) type and the like. In the AD-SDS technique, a multi-dimensional electric field is formed by a parallel electric field generated by edges of pixel electrodes in the same plane and a longitudinal electric field generated between a layer of pixel electrode and a layer of common electrode, so that orientations of all the liquid crystal molecules between and above the pixel electrodes within a liquid crystal cell can be revolved, thereby improving the operation efficiency of the liquid crystal molecules orientated in one plane and increasing the light transmittance.

Display device of ADS-type and IPS-type both comprise a color film substrate and an array substrate formed through a cell assembly process. The common electrodes and the pixel electrodes of both the ADS-type and the IPS-type display devices are arranged on the array substrate. FIGS. 1 and 2 show illustrative drawings of the base of the array substrate applied in the ADS-type display device, and FIG. 3 shows an illustrative drawing of the base of the array substrate applied in the IPS-type display device.

In the case of applying the array substrate for TFT-LCD in the IPS-type or ADS-type display device, the array substrate for TFT-LCD further comprises: a common electrode line electrically connected to a plurality of common electrodes; the second source electrode may directly electrically connected to the common electrode line.

As shown in FIGS. 1 and 2, in the array substrate for TFT-LCD used in ADS-type display device, the common electrode 4 and the pixel electrode 3 are positioned in different layers, the electrode positioned in an upper layer comprises a plurality of strip electrodes, the electrode positioned in the lower layer comprises a plurality of strip electrodes or a plate electrode. It is noted that the common electrodes are electrically connected to the common electrodes line whether positioned in the upper layer or in the lower layer, and the first drain electrode of the first TFT is electrically connected to the pixel electrode. That is to say, the pixel electrode may be positioned in the upper layer, and the common electrode may be positioned in the lower layer, alternatively, the common electrode may be positioned in the upper layer, and the pixel electrode may be positioned in the lower layer. In an exemplary embodiment, as shown in FIG. 2, the electrode in the upper layer, which comprises a plurality of strip electrodes, could be used as the pixel electrode, and the plate electrode in lower layer could be used as the common electrode.

The common electrode 4 and the pixel electrode 3 may be positioned in different layers for at least two different patterns, that is, at least two different patterns may be formed through patterning process in at least two films. In the case of two different patterns, two patterns could be formed in the two films through patterning process, respectively. For example, in the case of the common electrode and the pixel electrode being positioned in different layers, the electrode in the lower layer may be formed through patterning process by a first transparent conductive film, and the electrode in the upper layer may be formed through patterning process by a second transparent conductive film, wherein the electrode in the lower layer is used as one of the common electrode and the pixel electrode, and the electrode in the upper layer is used as the other of the pixel electrode and the common electrode.

As shown in FIG. 3, in the array substrate for IPS-type display device, the common electrode 4 and the pixel electrode 3 are positioned in the same layer, the common electrode 4 comprises a plurality of first strip electrodes, the pixel electrode 3 comprises a plurality of second strip electrodes, and the first and second strip electrodes are spaced apart alternatively.

The common electrode 4 and the pixel electrode 3 may be positioned in the same layer for at least two different patterns, that is, at least two different patterns may be formed through patterning process in the same film. For example, in the case where the common electrode and the pixel electrode is positioned in the same layer, the common electrode and the pixel electrode may be formed through patterning process by the same one transparent conductive film, wherein the pixel electrode is the electrode electrically connected to the data line through a switch unit, such as a TFT, and the common electrode is the electrode electrically connected to the common electrode line.

In an exemplary embodiment according to a further aspect of the present invention, there is provided a method for manufacturing the array substrate for TFT-LCD, the method comprises steps of forming common electrodes line, gate lines, data lines, common electrodes, first TFTs, and second TFTs in a transparent substrate, wherein a sub-pixel region is defined by the Nth, (N+1)th gate lines and two data lines; one pixel electrode, one common electrode, one first thin-film transistor (TFT) and one second TFT are provided in the sub-pixel region; the pixel electrode and the common electrode form a multi-dimensional electric field when powered; the first TFT comprises a first gate electrode, a first source electrode and a first drain electrode, and the second TFT comprises a second gate electrode, a second source electrode and a second drain electrode; the second gate electrode is electrically connected to a Nth gate line; wherein the Nth gate line comprises any one of the gate lines except the last one; the second drain electrode is correspondingly electrically connected to the pixel electrode which is connected to the first drain electrode of the first TFT driven by a (N+1)th gate line; the second source electrode is electrically connected to the common electrode line; and wherein during the gate line scanning process for one frame in the array substrate, the Nth gate line is always scanned in advance of the (N+1)th gate line.

According to an exemplary embodiment of the present invention, in the case of array substrate for ADS-type display device, the method of manufacturing the array substrate comprises the following steps of:

S1: forming a gate metal film on the transparent substrate, and at least forming the Nth gate line 81, the (N+1)th gate line 82, the first gate electrode 11 and the second gate electrode 12 through a patterning process; wherein the first gate electrode 11 is electrically connected to the (N+1)th gate line 82, the second gate electrode 12 is electrically connected to the Nth gate line 81. In an exemplary embodiment, while performing the patterning process, a common electrode line (no shown) may be further formed;

S2: forming a gate insulation layer 6 on the transparent substrate to cover the first and the second gate electrodes;

S3: forming semiconductor films at positions on the gate insulation layer 6 corresponding to the first gate electrode 11 and the second gate electrode 12, and forming active layers 7 through patterning process in the semiconductor film 6;

S4: forming a transparent conductive film on the gate insulation layer 6 in which the active layers 7 are formed, and forming the common electrode 4 through patterning process;

S5: forming a passivation layer film on the gate insulation layer 6, in which the common electrode 4 and the active layers 7 are formed, to cover the common electrode 4 and the active layer 7, and forming a via passing through a first passivation layer 51 on the common electrode 4;

S6: making a metal film on the first passivation layer 51, and at least forming the first source electrode 12, the first drain electrode 13, the second source electrode 22, the second drain electrode 23 and the data line through patterning process, wherein the second source electrode 22 is connected to the common electrode 4 through the via-hole formed in the first passivation layer 51;

S7: making a passivation layer film on the first passivation layer in which the first source electrode 12, the first drain electrode 13, the second source electrode 22, the second drain electrode 23 and the data line are at least formed, and forming a second passivation layer 52 provided with two second vias, the two vias in the second passivation layer 52 are located respectively above the first drain electrode 13 and the second drain electrode 23; and

S8: forming a transparent conductive film on the second passivation layer 52, and forming the pixel electrode 3 through patterning process, wherein the pixel electrode 3 is connected to the first drain electrode 13 and the second drain electrode 23 respectively through the second vias.

While one method of making the array substrate used in an ADS-type display device is described with reference to FIG. 2, the present invention is not limited thereto. The array substrate described in the embodiment of the present invention can also be used in other ADS-type display devices, and the configuration is not limited to that in FIG. 2 either. The process for manufacturing the array substrate used in other ADS-type display devices may make reference to the process as mentioned above.

According to another exemplary embodiment of the present invention, in the case that an array substrate is used in an IPS-type display device, the method of manufacturing the array substrate comprises the following steps of:

Q1: forming a gate metal film on a transparent substrate, and forming at least the Nth gate line, the (N+1)th gate line, the first gate electrode and the second gate electrode through patterning process; wherein the first gate electrode 11 is electrically connected to the (N+1)th gate line, the second gate electrode 12 is electrically connected to the Nth gate line. In an exemplary embodiment, while performing the patterning process, the common electrode line (no shown) may be further formed;

Q2: forming a gate insulation layer 6 on the transparent substrate to cover the first and the second gate electrodes; and forming active layers 7 at positions on the gate insulation layer 6 corresponding to the first gate electrode 11 and the second gate electrode 12;

Q3: forming a passivation layer film on the gate insulation layer 6, on which the active layers 7 are formed, to cover the active layers 7;

Q4: making a metal film on the first passivation layer 51, and at least forming the first source electrode 12, the first drain electrode 13, the second source electrode 22, the second drain electrode 23 and the data line through patterning process;

Q5: making a passivation layer film on the first passivation layer 51, in which the first source electrode 12, the first drain electrode 13, the second source electrode 22, the second drain electrode 23 and the data line are at least formed, to form a second passivation layer 52, and forming, through patterning process, first vias passing through the second passivation layer 52 on the first drain electrode 13 and the second drain electrode 23 respectively, and a second via-hole passing through the second passivation layer 52 on the second source electrode 22; and

Q6: forming a transparent conductive film on the second passivation layer 52, and forming, through patterning process, the pixel electrode 3 and the common electrode 4 that are spaced apart alternatively, wherein the pixel electrode 3 is connected to the first drain electrode 13 and the second drain electrode 23 respectively through the first vias in the second passivation layer 52, the common electrode 4 is connected to the second source electrode 22 through the second via in the second passivation layer 52.

While one method of making the array substrate for an IPS-type display device is described with reference to FIG. 3, the present invention is not limited thereto. The array substrate described in the embodiment of the present invention can also be used in other IPS-type display devices, and the configuration is not limited to that in FIG. 3 either. The process for manufacturing the array substrate used in other IPS-type display devices may make reference to the process as mentioned above.

In an exemplary embodiment according to a further aspect of the present invention, there is provide a display device comprising a color film substrate, a liquid crystal layer and an array substrate assembled by a cell assembly process, wherein the array substrate may comprise the array substrate for TFT-LCD described in any one of the above embodiments. The display device may comprise a liquid crystal display, a liquid crystal television, a digital camera, a mobile phone, a tablet computer and other products or components having a display function.

According to the array substrate for TFT-LCD, the method manufacturing the array substrate and the display device disclosed in various embodiments of the present invention, the second gate electrode of the second TFT is electrically connected to the Nth gate line, so that when the Nth gate line is being scanned, the second TFT is driven to operate, and turn on the second source electrode and the second drain electrode of the second TFT; then the second source electrode and the second drain electrode of the second TFT are electrically connected to the pixel electrode and the common electrode corresponding to the first TFT driven by the (N+1)th gate line respectively, so that the corresponding pixel electrode and common electrode, which are respectively connected to the first drain electrode and the first source electrode of the first TFT driven by the (N+1)th gate line, are turned on. In this way, the electric potential difference between the pixel electrode and the common electrode become zero, therefore the liquid crystal deflection phenomenon due to accumulation of charges on the pixel electrode is suppressed, the afterimage phenomenon is effectively eliminated, and the display quality of display device is improved.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. An array substrate for using in a TFT-LCD comprising:
a transparent substrate;
a plurality of gate lines and a plurality of data lines positioned crosswise on the transparent substrate to define a plurality of sub-pixel regions; and
a pixel electrode, a common electrode, a first TFT and a second TFT provided in a sub-pixel region defined by the Nth and (N+1)th gate lines of the plurality of gate lines and two data lines of the plurality of data lines, and the pixel electrode and the common electrode forming a multi-dimensional electric field when powered;
wherein a first gate electrode of the first TFT is connected to the (N+1)th gate line, a first source electrode of the first TFT is connected to one of the two data lines, a first drain electrode of the first TFT is connected to the pixel electrode; a second gate electrode of the second TFT is connected to the Nth gate line, a second drain electrode of the second TFT is connected to the pixel electrode, a second source electrode of the second TFT is connected to the common electrode; and
the Nth gate line comprises any one of the plurality of gate lines except the last one, and during a gate line scanning process for one frame in the array substrate, the Nth gate line is always scanned in advance of the (N+1)th gate line.

2. The array substrate according to claim 1, wherein the common electrode and the pixel electrode are positioned in the same layer, the common electrode comprises a plurality of first strip electrodes, the pixel electrode comprises a plurality of second strip electrodes, the first strip electrodes and the second strip electrodes are arranged alternatively.

3. The array substrate according to claim 1, wherein the common electrode and the pixel electrode are positioned in different layers, and wherein the electrode positioned in an upper layer comprises a plurality of strip electrodes, and the electrode positioned in a lower layer comprises a plurality of strip electrodes or a plate electrode.

4. A method for manufacturing an array substrate used in a TFT-LCD comprising steps of:
forming a plurality of gate lines, a plurality of data lines, a plurality of pixel electrodes, a plurality of common electrodes, a plurality of first TFTs and a plurality of second TFTs on a transparent substrate;
wherein a sub-pixel region is defined by the Nth and (N+1)th gate lines of the plurality of gate lines and two data lines of the plurality of data lines, one pixel electrode, one common electrode, one first TFT and one second TFT are included in the sub-pixel region, and the pixel electrode and the common electrode form a multi-dimensional electric field when powered;
a first gate electrode of the first TFT is connected to the (N+1)th gate line, a first source electrode of the first TFT is connected to one of the two data lines, a first drain electrode of the first TFT is connected to the pixel electrode;
a second gate electrode of the second TFT is connected to the Nth gate line, a second drain electrode of the second TFT is connected to the pixel electrode, a second source electrode of the second TFT is connected to the common electrode; and
the Nth gate line comprises any one of the plurality of gate lines except the last one, and during a gate line scanning process for one frame in the array substrate, the Nth gate line is always scanned in advance of the (N+1)th gate line.

5. The method according to claim 4, wherein the step of forming the plurality of gate lines, the plurality of data lines, the plurality of pixel electrodes, the plurality of common electrodes, the plurality of first TFTs and the plurality of second TFTs in the transparent substrate comprises steps of:
forming a gate metal film on the transparent substrate, and at least forming the Nth gate line, the (N+1)th gate line, the first gate electrode and the second gate electrode through patterning process; wherein the first gate electrode is electrically connected to the (N+1)th gate line, and the second gate electrode is electrically connected to the Nth gate line;
forming a gate insulation layer on the transparent substrate to cover the first and the second gate electrodes;
forming an active layers at positions on the gate insulation layer corresponding to the first gate electrode and the second gate electrode;
forming a transparent conductive film on the gate insulation layer in which the active layers are formed, and forming the common electrode through patterning process;
forming a first passivation layer on the gate insulation layer to cover the common electrode and the active layers, and forming a first via passing through the first passivation layer on the common electrode through patterning process;
forming a metal film on the first passivation layer, and at least forming the first source electrode, the first drain electrode, the second source electrode, the second drain electrode and the data line through patterning process, wherein the second source electrode is connected to the common electrode through the first via;
forming a second passivation layer film on the first passivation layer, and forming second vias passing through the second passivation layer on first drain electrode and the second drain electrode through patterning process, respectively; and
forming a transparent conductive film on the second passivation layer, and forming the pixel electrode through patterning process, wherein the pixel electrode is connected to the first drain electrode and the second drain electrode, respectively, through the second vias in the second passivation layer.

6. The method according to claim 4, wherein the step of forming the plurality of gate lines, the plurality of data lines, the plurality of pixel electrodes, the plurality of common electrodes, the plurality of first TFTs and the plurality of second TFTs in the transparent substrate comprises steps of:
forming a gate metal film on the transparent substrate, and at least forming the Nth gate line, the (N+1)th gate line, the first gate electrode and the second gate electrode through patterning process; wherein the first gate electrode is electrically connected to the (N+1)th gate line, and the second gate electrode is electrically connected to the Nth gate line;
forming a gate insulation layer on the transparent substrate to cover the first and the second gate electrodes;
forming active layers at positions on the gate insulation layer corresponding to the first gate electrode and the second gate electrode;
forming a first passivation layer film on the gate insulation layer, in which the active layers are formed, to cover the active layers;
forming a metal film on the first passivation layer, and at least forming the first source electrode, the first drain electrode, the second source electrode, the second drain electrode and the data line through patterning process;
forming a second passivation layer film on the first passivation layer, and forming, through patterning process, first vias passing through the second passivation layer on the first drain electrode and the second drain electrode, respectively, and a second via passing through the second passivation layer on the second source electrode; and
forming a transparent conductive film on the second passivation layer, and forming the pixel electrode and the common electrode that are arranged alternatively through patterning process, wherein the pixel electrode is connected respectively to the first drain electrode and the second drain electrode through the first vias, and the common electrode is connected to the second source electrode through the second via.

7. A display device, comprising a color film substrate and the array substrate according to claim 1 assembled by a cell assembly process.

8. The display device according to claim 7, wherein the common electrode and the pixel electrode are positioned in the same layer, the common electrode comprises a plurality of first strip electrodes, the pixel electrode comprises a plurality of second strip electrodes, the first strip electrodes and the second strip electrodes are arranged alternatively.

9. The display device according to claim 7, wherein the common electrode and the pixel electrode are positioned in different layers, and wherein the electrode positioned on the upper layer comprises a plurality of strip electrodes, and the electrode positioned in a lower layer comprises a plurality of strip electrodes or a plate electrode.
